(19) United States
(12) Patent Application Publication
(10) Pub. No.: US 2016/0163107 A1
(43) Pub. Date: Jun. 9, 2016

(54) Augmented Reality Method and System, and User Mobile Device Applicable Thereto

(71) Applicant: Industrial Technology Research Institute, Chutung (TW)

(72) Inventors: Szu-Wei CHEN, Taipei City (TW); Yi-Cheng CHEN, New Taipei City (TW); Teng-Wen CHANG, Taoyuan City (TW); Che-Wei LIANG, Taichung City (TW)

(21) Appl. No.: 14/743,810

(22) Filed: Jun. 18, 2015

(30) Foreign Application Priority Data
Dec. 9, 2014 (TW) 103142734

(51) Int. Cl. G06T 19/00; H04N 13/02; G06T 7/00

(52) U.S. Cl. CPC G06T 19/006; G06T 7/0042; G06T 7/0051; H04N 13/0207; H04N 13/0271; G06T 2207/10028; G06T 2207/30204

(57) ABSTRACT

An augmented reality method includes: capturing physical objects in a physical space, to obtain respective depth information of the physical objects; generating respective physical coordinates of the physical objects; generating a 3D map of the physical space; searching an AR deposition corresponding to the physical space; converting respective AR virtual coordinates of a plurality AR objects in the AR deposition into respective physical coordinates of the AR objects in the physical space; judging whether an AR alignment error occurs; if yes, adjusting a first AR virtual coordinate of a first AR object, among the AR objects, which causes the AR alignment error; and performing AR demonstration.

This application claims the benefit of Taiwan application Serial No. 103142734, filed Dec. 9, 2014, the disclosure of which is incorporated by reference herein in its entirety.

### TECHNICAL FIELD

The disclosure relates in general to an augmented reality method and system, and a user mobile device applicable thereto.

### BACKGROUND

Via physical deposition, people who want to buy house may see the real furniture deposition in the house. By this, the house deal probability is higher and the favorite of the possible buyer may be known. After AR (augment reality) technology is developed, the designer and the developer may upload their design pattern and the virtual furniture onto an AR development platform. Thus, the consumer may see the combination of the virtual furniture and the physical house condition on his/her mobile device.

An augmented reality method and system are provided. Demonstration pattern and demonstration size may be changed in response to different client favorite and/or desire.

### SUMMARY

The disclosure is directed to an augmented reality method and system, which captures the physical space to construct respective physical coordinates of the physical objects in the physical space and to construct the 3D map of the physical space. Thus, the respective physical coordinates of the virtual objects are compared with the physical objects to adjust the display location of the virtual objects.

According to one embodiment, an augmented reality (AR) method is provided. The AR method includes: capturing a plurality of physical objects in a physical space by a user mobile device to obtain respective depth information of the physical objects; generating respective physical coordinates of the physical objects by the user mobile device to send to an AR server system; generating a three-dimension (3D) map of the physical space by the AR server system; searching an AR deposition corresponding to the physical space by the AR server system; converting respective AR virtual coordinates of a plurality AR objects in the AR deposition into respective physical coordinates of the AR objects in the physical space; judging, by the AR server system, whether an AR alignment error occurs; if yes, adjusting a first AR virtual coordinate of a first AR object, among the AR objects, which causes the AR alignment error, by the AR server system; and performing AR demonstration by the user mobile device.

According to another embodiment, an augmented reality (AR) system is provided. The AR system includes: a user mobile device, capturing a plurality of physical objects in a physical space to obtain respective depth information of the physical objects; and an AR server system, coupled to the user mobile device. The AR server system includes: a physical space generation module, receiving the respective physical coordinates of the physical objects generated by the user mobile device to generate a three-dimension (3D) map of the physical space; an AR object intelligent suggestion module, searching an AR deposition corresponding to the physical space; an AR space conversion module, converting respective AR virtual coordinates of a plurality AR objects in the AR deposition into respective physical coordinates of the AR objects in the physical space; and an AR space correction module, judging whether an AR alignment error occurs, if yes, the AR space correction module adjusting a first AR virtual coordinate of a first AR object, among the AR objects, which causes the AR alignment error. The AR object intelligent suggestion module sends back the adjusted AR deposition to the user mobile device and the user mobile device performs AR demonstration.

According to still another embodiment, a user mobile device is provided. The user mobile device includes: a 3D depth camera, a plurality of physical objects in a physical space to obtain respective depth information of the physical objects; and a 3D space generating module. When a physical marker and the user mobile device are placed in a location of the physical space, the 3D space generating module obtains respective distances between walls and the location of the physical space to calculate an area of the physical space. The 3D space generating module generates respective physical coordinates of the physical objects to send to an AR server system. After receiving the respective physical coordinates of the physical objects from the user mobile device, the AR server system generate a three-dimension (3D) map of the physical space, searches and adjusts an AR deposition corresponding to the physical space, sends back the AR deposition to the user mobile device. The user mobile device performs AR demonstration.

### BRIEF DESCRIPTION OF THE DRAWINGS

FIG. 1 shows a functional block diagram for an augmented reality system according to an embodiment of the application.

FIGS. 2A-2E show AR demonstration and how to solve AR deposition error according to an embodiment of the application.

FIG. 3 shows a flow chart diagram for an augmented reality method according to an embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

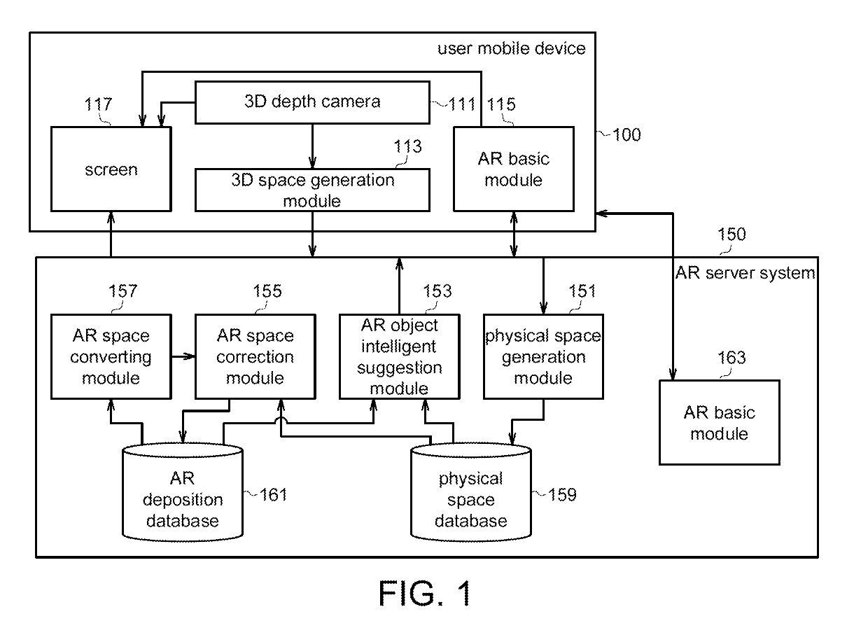

FIG. 1 shows a functional block diagram for an augmented reality system according to an embodiment of the application. As shown in FIG. 1, a user mobile device 100 according to an embodiment of the application at least includes: a three-dimensional (3D) depth camera 111, a 3D space generation module 113, an AR basic module 115 and a screen 117. The AR server system 150 at least includes: a physical space generation module 151, an AR object intelligent suggestion module 153, an AR space correction module 155, an AR space converting module 157, a physical space database 159, an AR deposition database 161 and an AR basic module 163. The 3D space generation module 113 and the AR basic module 115 may be provided by an AR application (not shown) installed on the user mobile device 100. Alternatively, the modules 113, 115, 151-163 may be implemented by hardware or firmware.

Although not shown in FIG. 1, the user mobile device 100 may further include a processor, a memory and so on. The user mobile device 100 may be implemented by a smart phone, a tablet PC (personal computer) etc.

The 3D depth camera 111 of the user mobile device 100 may take or capture a picture and/or sense the physical space, to obtain the 2D images and the corresponding depth information of the physical objects in the physical space. The 3D depth camera 111 may send the 2D images and the corresponding depth information of the physical objects to the 3D space generation module 113 and thus the 3D space generation module 113 generates the respective physical 3D coordinates of the physical objects in the physical space. For example, taken a room whose size is 15 m² as an example, the user may use the user mobile device 100 to take photos by surrounding the room, for taking photos of the physical objects (for example but not limited by, walls, chairs, tables, physical markers and so on) in the physical space. Further, the 3D depth camera 111 may detect the depth information of the pixels in the 2D images.

In photographing, the user may take photos one by one, and then the AR application installed in the user mobile phone 100 may combine the 2D images. The 3D space generation module 113 may generate the physical coordinates of the physical objects in the physical space.

Further, in photographing, the user mobile device 100 and the physical marker may be located in a center location in the physical space. The 3D space generation module 113 of the user mobile device 100 may calculate the respective distance between the respective wall and the center location, to calculate the size of the physical space.

The physical coordinates of the physical objects, which are obtained by the 3D space generation module 113, are sent to the AR server system 150 via Internet, for example.

The AR basic module 115 is an AR related basic module and the details thereof are omitted. The screen 117, coupled to the 3D depth camera 111 and the AR basic module 115, may display the photos taken/captured by the 3D depth camera 111 and the AR space deposition sent from the AR server system 150. For example, the AR deposition from the AR server system 150 is received by the AR basic module 115 and thus the AR basic module 115 controls the screen 117 to display the AR deposition.

The physical space generation module 151 of the AR server system 150 constructs a 3D map of the physical space based on the physical coordinates of the physical space sent from the 3D space generation module 113, and stores the 3D map in the physical space database 159. That is, physical space generation module 151 constructs the respective physical 3D locations of the physical objects (for example, the physical chairs and the physical table) in the physical space, and stores in the physical space database 159.

The AR object intelligent suggestion module 153 searches an AR deposition (suitable or corresponding to the physical space) from a plurality of predesigned AR depositions of the AR deposition database 161. For example, if a room has a size of 15 m², then the AR object intelligent suggestion module 153 searches an AR deposition suitable to 15 m² room from the AR deposition database 161.

If the AR deposition suggested/searched by the AR object intelligent suggestion module 153 causes the AR objects suffered from problems, such as, blocking, passing-through, when the AR objects are virtually deposited in the physical space, then the AR space correction module 155 adjusts/corrects the location of the AR objects in the physical space, to solve the blocking, passing-through and so on. Details are described in follows.

In AR deposition, an AR virtual marker is included. The location, direction, size, distances of the AR objects are referred to the AR marker. Thus, in the embodiment of the application, the AR space converting module 157 may search the space parameters (for example, the location parameter, the direction parameter, the size parameter, the distance parameter) of the AR objects (which are to be included in the AR deposition) relative to the AR marker, and send to the AR space correction module 155. That is, the AR space converting module 157 may convert the virtual coordinates of the AR objects in the AR deposition into the physical coordinates of the AR objects in the physical space.

The AR space converting module 157 calculates the area/size of the suggested AR deposition, calculates the area/size of the AR marker in the virtual space, and calculates the area/size of the AR marker in the physical space.

The AR basic module 163 may include other AR modules which may be used by the AR server system 150 when the AR server system 150 performs AR operations.

In the embodiment, how to address the AR alignment error of AR objects is described.

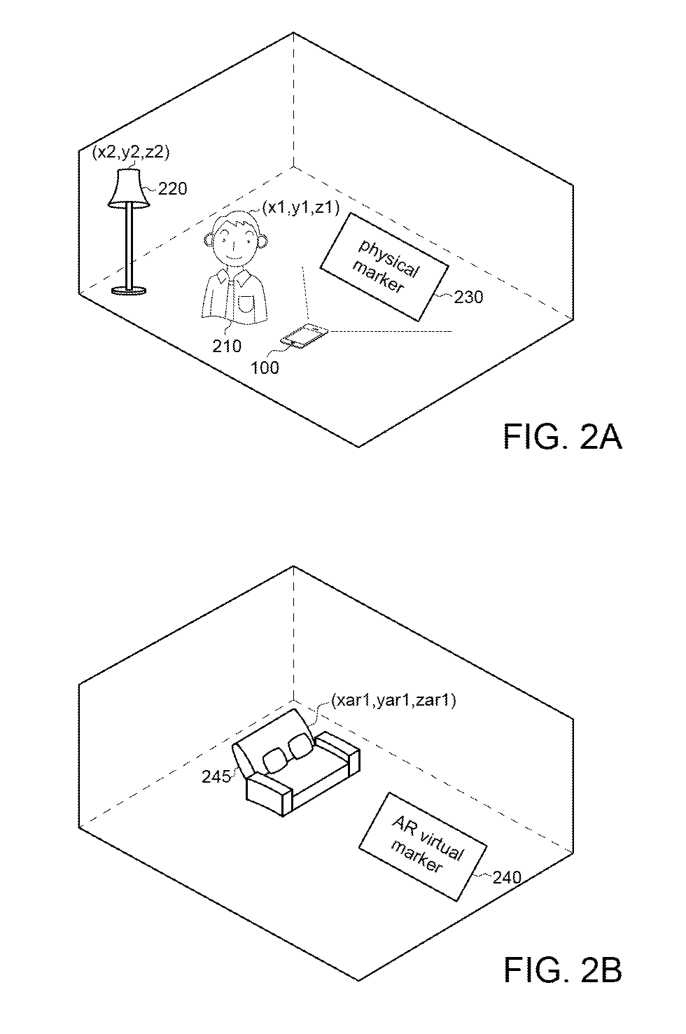

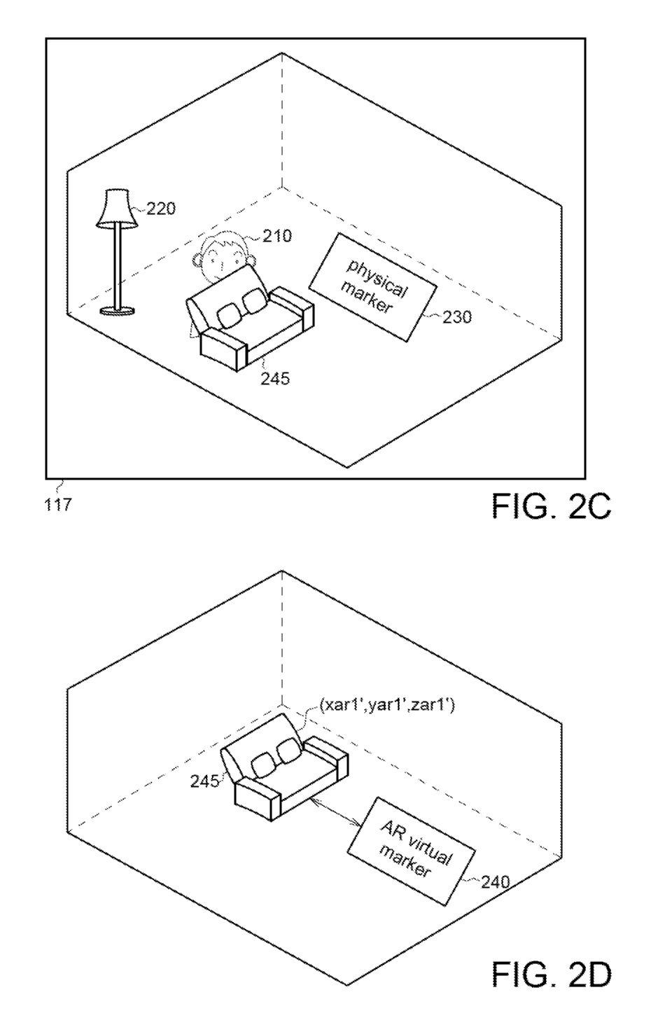

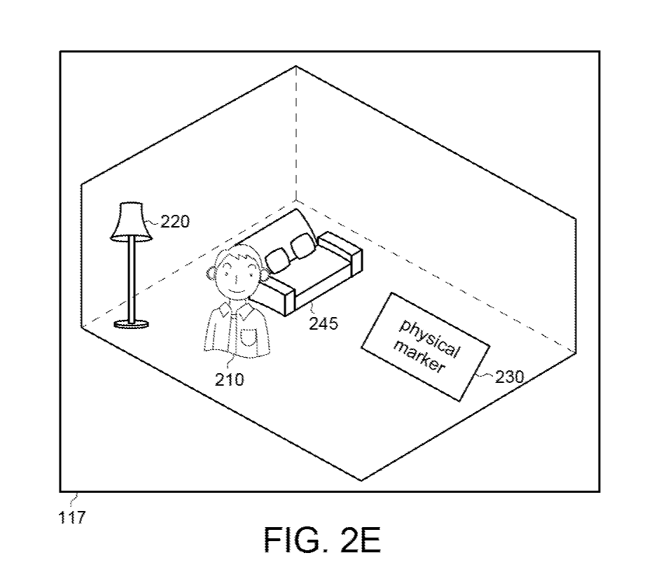

As shown in FIG. 2A, the user mobile device 100 photographs/captures the physical space to construct the physical coordinates of the physical objects in the physical space. For example, the physical coordinates of the man 210 and the desk lamp 220 are (x1, y1, z1) and (x2, y2, z2), respectively. The user mobile device 100 may predict the size of the physical space. The user mobile device 100 sends the physical coordinates of the physical objects (for example, the man 210, the desk lamp 220 and the physical marker 230) in the physical space to the physical space generation module 151 via Internet and thus the physical space generation module 151 constructs the 3D map of the physical space. That is, the physical space generation module 151 may obtain the physical locations of the physical objects (for example, the man 210, the desk lamp 220 and the physical marker 230) in the physical space.

The AR object intelligent suggestion module 153 searches from the AR deposition database 161 about the AR deposition, the AR object arrangement, the AR space suitable to the physical space, as shown in FIG. 2B. The size of the AR space is to be suitable to the size of the physical space. For example, if the physical space is 15 m², the AR space is about 15 m². Although the AR objects and the AR deposition are shown in FIG. 2B, but for simplicity, the physical objects are not shown in FIG. 2B. The AR objects searched by the AR object intelligent suggestion module 153 include the AR virtual marker 240 and the AR virtual sofa 245, for example, but not limited by.

The AR space converting module 157 may convert the virtual coordinates in the AR space into the physical coordinates in the physical space. That is, the AR space converting module 157 may calculate the space parameters (the locations, the direction, the size and the distance, for example, but not limited by) of the AR virtual sofa 245 relative to the AR virtual marker 240, to calculate the physical coordinates of the AR objects in the physical space, and to send to the AR space correction module 155. In details, because the AR space is designed in advance (and thus the size of the AR space is also designed in advance), and the size and the location of the AR virtual marker 240 in the AR space is also designed in advance, the AR space converting module 157 may obtain the space parameters of the AR objects in the AR space and convert into the physical coordinates of the AR objects in the physical space. That is, the AR space converting module 157 may obtain that the physical coordinates of the AR virtual sofa 245 in the physical space is (xar1, yar1, zar1).

Thus, the AR space correction module 155 may judge that whether the AR objects are error aligned based on the physical coordinates of the physical objects and the physical coordinates of the AR objects. For example, after coordinate conversion, the AR space converting module 157 judges that whether in AR demonstration, the AR virtual sofa 245, whose initial location is (xar1, yar1, zar1), will block any physical object in the physical space, or whether the virtual sofa 245 will pass through the wall, as shown in FIG. 2C.

If the AR objects are error aligned/arranged, the AR space correction module 155 will correct the locations, the physical coordinates, and/or the virtual coordinates of the AR objects. For example, in the embodiment, the AR space converting module 157 may calculate the desired adjustments of the coordinates of the AR virtual sofa 245 (whose location is to be corrected) on the x-direction and the y-direction, respectively, and calculate the moved/corrected physical coordinate of the AR virtual sofa 245 in the physical space.

Thus, the AR space correction module 155 adjusts the AR virtual sofa 245 in the AR space (and accordingly, the location of the AR virtual sofa 245 in the physical space is also adjusted) until that the man 210 will not be blocked by the AR virtual sofa 245. For example, after correction, the physical coordinate of the AR virtual sofa 245 is as (xar1′, yar1′, zar1′), as shown in FIG. 2D. That is, the AR space correction module 155 adjusts the arrangement, the location, the direction of the AR objects for addressing AR error alignment/arrangement.

The AR space correction module 155 stores the corrected coordinates of the AR objects (for example, the corrected virtual coordinates of the AR objects) to the AR deposition database 161. The AR object intelligent suggestion module 153 reads the corrected AR object deposition from the AR deposition database 161 and sends to the user mobile device 100. The user mobile device 100 may display the AR object deposition and the captured images in real-time on the screen 117, as shown in FIG. 2E. From FIG. 2E, after AR deposition adjustment, the AR virtual sofa 245 displayed on the screen 117 of the user mobile device 100 will not block the man 210.

Further, in an embodiment of the application, if the AR space correction module 155 corrects the arrangement location of one of the AR object, other AR objects which are considered as a pair in people usual/life habits will be adjusted/corrected together. For example, the AR objects include AR virtual sofa and AR virtual table which are usually demonstrated in pair. If the AR space correction module 155 determines that the arrangement location of the AR virtual sofa is to be corrected/adjusted, the AR space correction module 155 will adjust/correct the arrangement location of the AR virtual sofa and the AR virtual table together. By so, after location adjustment, in AR demonstration, the AR virtual sofa and the AR virtual table, which are designed to be demonstrated in pair, are still demonstrated in pair and the user will not have a strange feel. On the contrary, if in location adjustment, one of the AR objects in pair is adjusted but the other of the AR objects in pair is not adjusted, then in AR demonstration, the user will not feel that the AR objects, which were designed to be demonstrated in pair, are in pair, which is not friendly to the user. The embodiment of the application will take the user experience into consideration.

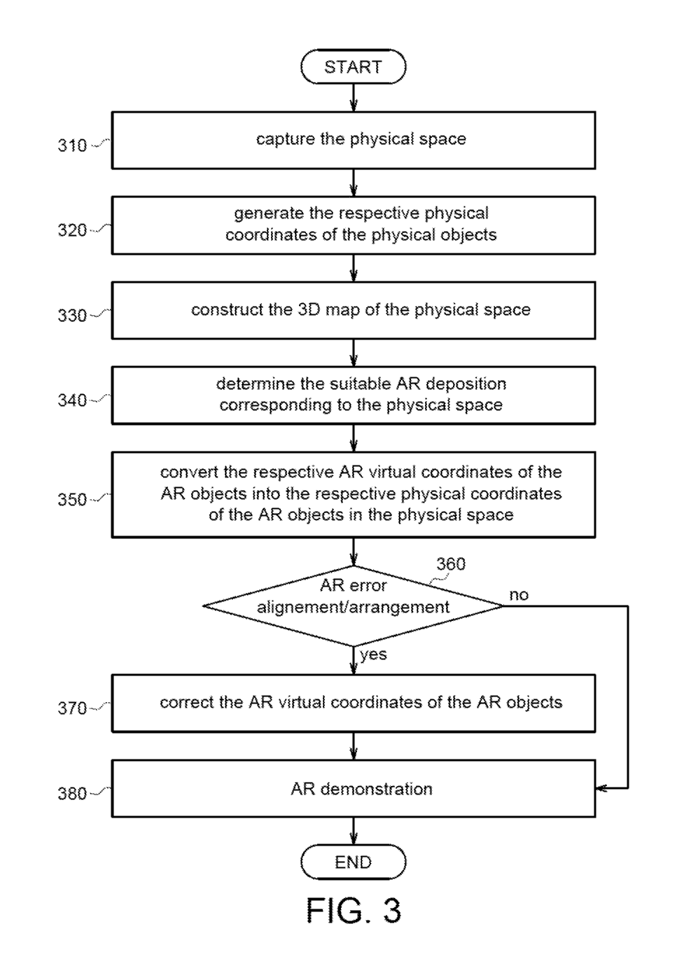

FIG. 3 shows a flow chart diagram for an augmented reality method according to an embodiment of the application. As shown in FIG. 3, in step 310, the physical objects in the physical space are captured to obtain the respective depth information of the physical objects. In step 320, the respective physical coordinates of the physical objects are generated. In step 330, the 3D map of the physical space is constructed. In step 340, the suitable AR deposition corresponding to the physical space is determined. In step 350, the respective AR virtual coordinates of the AR objects in the AR deposition are converted into the respective physical coordinates of the AR objects in the physical space. In step 360, whether AR deposition is error aligned/arranged (for example but not limited by, block, overlap, passing-through-wall) is judged. If AR error alignment/arrangement is occurred, then the AR virtual coordinates of the AR objects are corrected until the AR error alignment/arrangement is settled, as shown in step 370. In step 380, AR demonstration is performed. Details of the steps in FIG. 3 may be referred to the above description of the embodiment and thus are omitted here.

The AR implementation of the embodiment of the application may solve the prior high business dispense cost, time-consuming, man-power-consuming problems which is caused by arranging physical furniture in the house. The user may install the AR application in the user mobile device. When the user reaches the physical space (i.e. the house object which is to be sale or rented out), the user may operate the AR application for performing AR demonstration in real-time. The physical furniture demonstration is eliminated and thus, cost and time are reduced.

In prior art, an AR virtual marker may represent a single AR deposition, and a plurality of AR virtual markers are needed in multiple AR demonstration. On the contrary, for multiple AR demonstration, the embodiment of the application does not need a plurality of AR virtual markers, and even a single AR marker may meet the requirements for multiple furniture AR demonstration in a physical space.

Furthermore, if the user wants to change a furniture type, in the embodiment of the application, the user does not have to download and register AR object again. The user may click the menu on the AR application of the user mobile device to change the objects in real-time and on-line.

Besides, in general the house may have different layout from other houses and some houses may have complicated layout. In the prior art, a respective arrangement pattern is customized for each different house size, which consumes high design cost and time. On the contrary, in the embodiment of the application, the user may change AR demonstration in real-time by operating the AR application which reduces time and cost.

In the embodiment of the application, the user may adjust the AR demonstration size on the AR application, even without the help of the AR designer, and thus AR demonstration is adapted for a lot of different size/layout which is friendly to user.

In AR demonstration, the AR server system/platform may collect the user behavior/favorite to provide the client habit and favorites to the house estate agent for improving house transaction possibility.

Besides, in the embodiment of the application, the user mobile device having a 3D depth camera which may sense the depth information and an AR application is installed in the user mobile device is enough. In AR demonstration, the user mobile device is linked to the AR server system and the physical coordinates of the physical objects are sent to the AR server system from the user mobile device. Thus, the hardware requirement of the user mobile device is not too high. On the contrary, in the prior art, the user mobile device has to solve the AR error alignment/arrangement, and thus the hardware requirement of the prior user mobile device is very high.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An augmented reality (AR) method, comprising:
capturing a plurality of physical objects in a physical space by a user mobile device to obtain respective depth information of the physical objects;
generating respective physical coordinates of the physical objects by the user mobile device to send to an AR server system;
generating a three-dimension (3D) map of the physical space by the AR server system;
searching an AR deposition corresponding to the physical space by the AR server system;
converting respective AR virtual coordinates of a plurality AR objects in the AR deposition into respective physical coordinates of the AR objects in the physical space;
judging, by the AR server system, whether an AR alignment error occurs;
if yes, adjusting a first AR virtual coordinate of a first AR object, among the AR objects, which causes the AR alignment error, by the AR server system; and
performing AR demonstration by the user mobile device.

2. The AR method according to claim 1, further comprising:
placing a physical marker and the user mobile device having a 3D depth camera in a location of the physical space; and
obtaining respective distances between walls and the location of the physical space by the user mobile device to calculate an area of the physical space.

3. The AR method according to claim 1, wherein:
the AR server system stores the 3D map of the physical space into a physical space database; and
the AR server system searches the AR deposition corresponding to the physical space from an AR deposition database.

4. The AR method according to claim 1, wherein:
the AR server system calculates an area of the AR deposition;
the AR server system finds an area of an AR virtual marker in the AR deposition; and
the AR server system calculates an area of the AR virtual marker in the physical space.

5. The AR method according to claim 1, wherein the step of judging whether the AR alignment error occurs includes:
judging whether the AR alignment error occurs based on the respective physical coordinates of the physical objects and the respective physical coordinates of the AR objects.

6. The AR method according to claim 5, wherein
judging whether the AR alignment error occurs based on judging whether the AR objects block or overlap at least one of the physical objects in the physical space; or
judging whether the AR alignment error occurs based on judging whether the AR objects pass through at least one wall of the physical space.

7. The AR method according to claim 1, wherein if the first AR object and a second AR object are in pair, then the first AR virtual coordinate of the first AR object and a second AR virtual coordinate of the second AR object are adjusted together.

8. An augmented reality (AR) system, comprising:
a user mobile device, capturing a plurality of physical objects in a physical space to obtain respective depth information of the physical objects; and
an AR server system, coupled to the user mobile device, the AR server system including:
a physical space generation module, receiving the respective physical coordinates of the physical objects generated by the user mobile device to generate a three-dimension (3D) map of the physical space;
an AR object intelligent suggestion module, searching an AR deposition corresponding to the physical space;
an AR space conversion module, converting respective AR virtual coordinates of a plurality AR objects in the AR deposition into respective physical coordinates of the AR objects in the physical space; and
an AR space correction module, judging whether an AR alignment error occurs, if yes, the AR space correction module adjusting a first AR virtual coordinate of a first AR object, among the AR objects, which causes the AR alignment error;
wherein the AR object intelligent suggestion module sends back the adjusted AR deposition to the user mobile device and the user mobile device performs AR demonstration.

9. The AR system according to claim 8, wherein the user mobile device comprises:
a 3D depth camera, for capturing; and
a 3D space generating module,
wherein when a physical marker and the user mobile device are placed in a location of the physical space, the 3D space generating module obtains respective distances between walls and the location of the physical space to calculate an area of the physical space.

10. The AR system according to claim 8, wherein the AR server system further includes a physical space database and an AR deposition database,
the physical space generation module stores the 3D map of the physical space into the physical space database; and
the AR object intelligent suggestion module searches the AR deposition corresponding to the physical space from the AR deposition database.

11. The AR system according to claim 8, wherein:
the AR space conversion module calculates an area of the AR deposition;
the AR space conversion module finds an area of an AR virtual marker in the AR deposition; and
the AR space conversion module calculates an area of the AR virtual marker in the physical space.

12. The AR system according to claim 8, wherein the AR space correction module judges whether the AR alignment error occurs based on the respective physical coordinates of the physical objects and the respective physical coordinates of the AR objects.

13. The AR system according to claim 12, wherein the AR space correction module judges whether the AR alignment error occurs based on judging whether the AR objects block or overlap at least one of the physical objects in the physical space; or
the AR space correction module judges whether the AR alignment error occurs based on judging whether the AR objects pass through at least one wall of the physical space.

14. The AR system according to claim 8, wherein if the first AR object and a second AR object are in pair, then the AR space correction module adjusts the first AR virtual coordinate of the first AR object and a second AR virtual coordinate of the second AR object together.

15. A user mobile device, comprising:
a 3D depth camera, capturing a plurality of physical objects in a physical space to obtain respective depth information of the physical objects; and
a 3D space generating module,
wherein when a physical marker and the user mobile device are placed in a location of the physical space, the 3D space generating module obtains respective distances between walls and the location of the physical space to calculate an area of the physical space;
the 3D space generating module generates respective physical coordinates of the physical objects to send to an AR server system;
after receiving the respective physical coordinates of the physical objects from the user mobile device, the AR server system generates a three-dimension (3D) map of the physical space, converts coordinates of a plurality of AR objects, searches and adjusts an AR deposition corresponding to the physical space, sends back the AR deposition to the user mobile device; and
the user mobile device performs AR demonstration.

16. The user mobile device according to claim 15, further comprising:
an AR basic module, receiving the AR deposition from the AR server system;
a screen, coupled to the 3D depth camera and the AR basic module, displaying photos captured by the 3D depth camera and displaying the AR deposition from the AR basic module.
